(19) United States
(12) Patent Application Publication
(10) Pub. No.: US 2026/0339900 A1
(43) Pub. Date: Oct. 29, 2026

(54) EFFICIENT LOG DATA STORAGE BY REMOVING REDUNDANT INFORMATION AND USING IDENTIFIED INFORMATION

(71) Applicant: SAP SE, Walldorf (DE)

(72) Inventor: Hui Li, Shanghai (CN)

(21) Appl. No.: 19/192,750

(22) Filed: Apr. 29, 2025

(51) Int. Cl. G06F 16/18; G06F 8/70; G06F 9/30

(52) U.S. Cl. CPC G06F 16/1805; G06F 8/70; G06F 9/30036

(57) ABSTRACT

A large language model (LLM) is used to detect statements in source code that generate log entries. The log-generating statements include information used to format the log entries. Log entry templates are generated from the log-generating statements and each unique log entry template is stored in a database along with a unique identifier for the log entry template. Log entries in generated log data are evaluated to determine which log entry template best matches each log entry. The log entries are modified by removing redundant information and inserting the unique identifier for the log entry template. Sequences of generated log data may be modified by omitting repeated data values, using relative data values (e.g., inserting time elapsed since a previous log entry in place of a timestamp), or any suitable combination thereof.

### TECHNICAL FIELD

The subject matter disclosed herein generally relates to systems for efficient log data storage.

### BACKGROUND

Monitoring the operation of cloud systems is important to verify proper functioning and to detect threats. Thus, cloud systems generate log data that can be reviewed for monitoring purposes. However, as more systems are migrated to the cloud, the amount of log data being generated continues to increase.

One method of dealing with the increasing amount of log data is to periodically purge the log data, retaining only the most recent logs. However, the absence of historical log data reduces the value of the log data.

### BRIEF DESCRIPTION OF THE DRAWINGS

FIG. 1 shows a network diagram illustrating an example network environment suitable for efficient log storage.

FIG. 2 shows a block diagram of an application server, suitable for efficient log storage.

FIG. 3 is a block diagram of a neural network, suitable for determining log templates, embedding vectors, or any suitable combination thereof.

FIG. 4 shows an example of source code for a computer program that generates log entries.

FIG. 5 shows an example of source code for a computer program that generates log entries.

FIG. 6 shows an example database schema for storing log templates.

FIG. 7 shows an example log file.

FIG. 8 shows the example log file of FIG. 7, reduced in size by the use of log templates.

FIG. 9 shows a compressed log file, which is the compressed log file of FIG. 8, further reduced in size by the use of relative timestamps.

FIG. 10 shows an example flowchart of a method for efficiently storing log data.

FIG. 11 shows an example flowchart of a method for efficiently storing log data.

FIG. 12 shows an example flowchart of a method for efficiently storing log data.

FIG. 13 shows an example flowchart of a method for decompressing compressed log data.

FIG. 14 shows a block diagram showing one example of a software architecture for a computing device.

FIG. 15 shows a block diagram of a machine in the example form of a computer system within which instructions may be executed for causing the machine to perform any one or more of the methodologies discussed herein.

### DETAILED DESCRIPTION

Example methods and systems are directed to efficient storage of log data. As discussed herein, a large language model (LLM) is used to detect statements in source code that generate log entries. The log-generating statements include information used to format the log entries. Log entry templates are generated from the log-generating statements and each unique log entry template is stored in a database along with a unique identifier for the log entry template.

Log entries in generated log data are evaluated to determine which log entry template best matches each log entry. The log entries are modified by removing redundant information and inserting the unique identifier for the log entry template. Sequences of generated log data may be modified by omitting repeated data values, using relative data values (e.g., inserting time elapsed since a previous log entry in place of a timestamp), or any suitable combination thereof.

As discussed herein, systems and methods for efficiently storing log data are provided. By use of the described systems and methods, the amount of data storage used for logs is reduced. By comparison with systems that store log data in raw form, storage usage is reduced. By comparison with systems that periodically purge log data, the coverage provided by the log data is increased. As a result, the functioning of the log data storage system itself is improved.

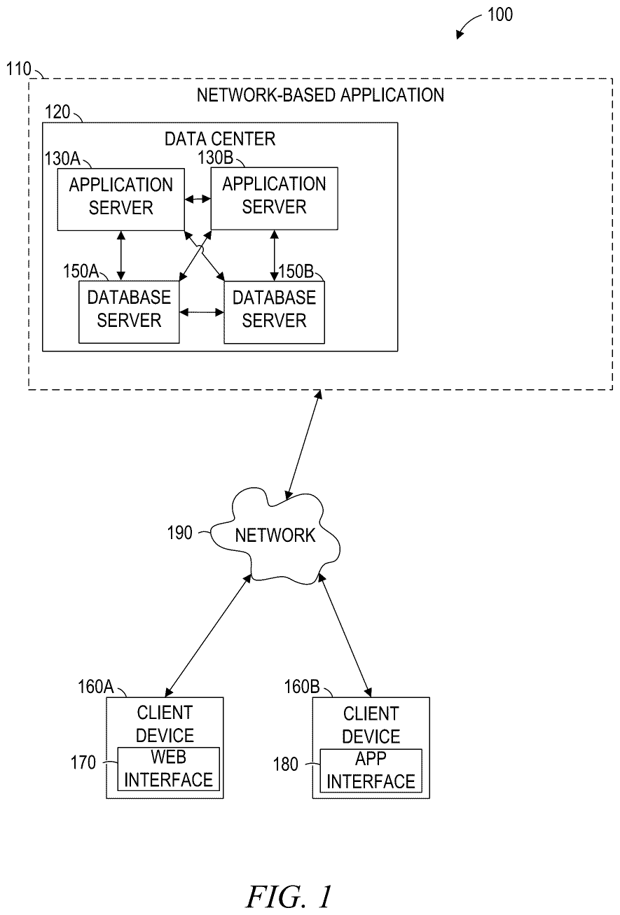

FIG. 1 shows a network diagram illustrating an example network environment 100 suitable for efficient log storage. The network environment 100 includes a network-based application 110, client devices 160A and 160B, and a network 190. The network-based application 110 is implemented at a data center 120 comprising application servers 130A and 130B in communication with database servers 150A and 150B. An application executing on the application servers 130A-130B may access data from the database servers 150A-150B. The letter suffixes of reference numbers may be omitted when doing so does not cause ambiguity. Thus, the application servers 130A-130B may be referred to collectively as “application servers 130.” Similarly, the client devices 160A-160B may be referred to collectively as “client devices 160” and the database servers 150A-150B may be referred to collectively as “database servers 150.” Furthermore, when the specific one of the application servers 130A-130B, client devices 160A-160B, or database servers 150A-150B is not of particular import, “application server 130,” “client device 160,” or “database server 150” may be referenced.

The application running on the application server 130 may provide services to the client devices 160A and 160B. For example, a user of the client device 160A may be an employee of a business using a business application. The user may use the services to generate invoices, manage employees, develop other applications, or any suitable combination thereof. Use of the application may entail filtering data (e.g., to review certain invoices, employees, applications, or the like). The user interface for the application may be presented using a web interface 170 or an app interface 180.

The application servers 130 may communicate with the database servers 150 using a representational state transfer (REST) application programming interface (API), the Open Data Protocol (ODATA), or another API. The data may be described in metadata that provides contextual information related to the data. Metadata includes column names, data types, and data relationships. If the values are from a fixed dataset, the dataset may be loaded and the loaded information used as a table description.

The application servers 130 may generate log data while executing application code. The log data may be stored by the database servers 150. To reduce the amount of data storage consumed by the log data, the generated log data may be periodically compressed.

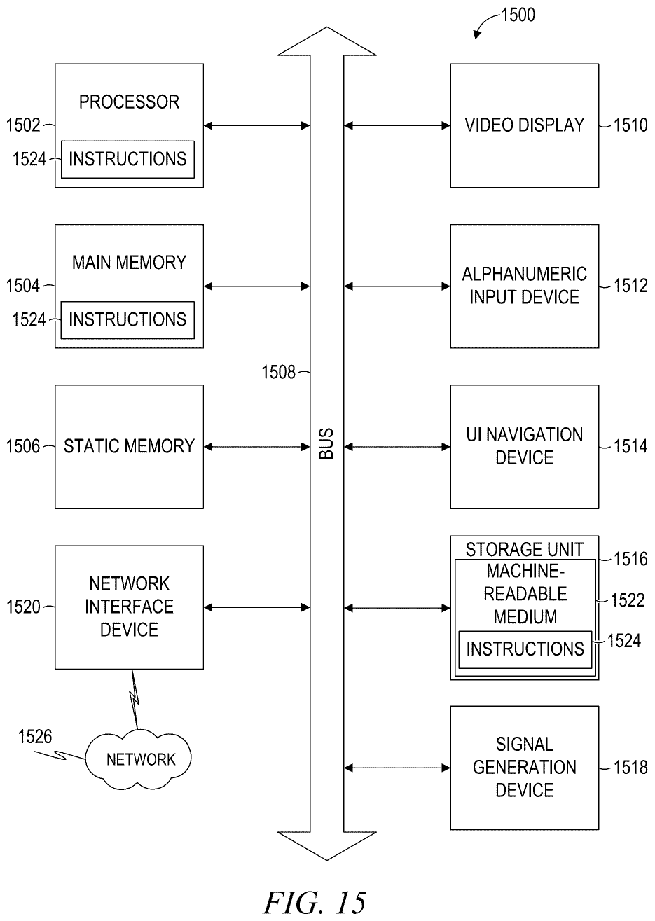

The application servers 130A-130B, the database servers 150A-150B, and the client devices 160A-160B may each be implemented in a computer system, in whole or in part, as described below with respect to FIG. 15. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 15. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database, a disk-based database, a remote database, or any suitable combination thereof. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130A-130B, the database servers 150A-150B, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., two application servers 130A-130B, two client devices 160A and 160B, and the like), any number of each element is contemplated. For example, the application server 130A may be one of dozens or hundreds of active and standby servers and provide services to millions of client devices.

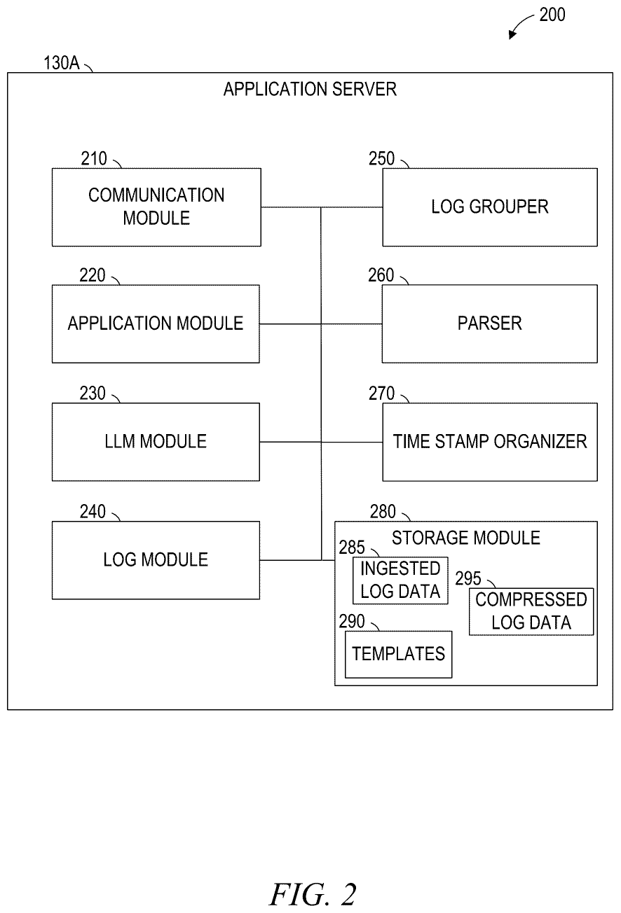

FIG. 2 shows a block diagram 200 of an application server, suitable for efficient log storage. The application server 130A is shown as including a communication module 210, an application module 220, an LLM module 230, a log module 240, a log grouper 250, a parser 260, a time stamp organizer 270, and a storage module 280, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the application server 130A and transmits data from the application server 130A. For example, the communication module 210 may send a user interface (e.g., HTML for rendering in a web browser) to the client device 160A. The communication module 210 may receive, from the client device 160A and via the user interface, a request to determine an allocation of resources to microservices.

The application module 220 implements one or more applications. For example, the application module 220 may implement a spreadsheet application or a data services application. While providing the one or more applications, log data may be generated by the application module 220. The generated log data may be stored by the storage module 280 as ingested log data 285.

The LLM module 230 accesses (e.g., via the network 190) one or more LLMs. A prompt may be provided to an LLM to request the LLM to detect log entry formats, generate log entry templates, determine embedding vectors for log entry templates or log entries, or any suitable combination thereof. The generated log entry templates may be stored by the storage module 280 as templates 290.

The log module 240 works with the LLM module 230, the log grouper 250, the parser 260, and the time stamp organizer 270 to process the ingested log data 285 to generate compressed log data 295. The compressed log data 295 consumes less storage space than the ingested log data 285. After compression, the ingested log data 285 may be deleted. As a result, fewer storage resources are used to store the log data after compression

The log grouper 250 accesses the ingested log data 285 and groups log entries by trace identifier. This allows groups of log entries to be compressed together, removing redundant information that is common to all log entries in the same trace. For example, every log entry in the same trace may include an identical user identifier, which can be stored once for the group and deleted from each log entry in the group, thereby saving space.

The parser 260 parses each log entry to find a source file name that generated the log entry. The source file name is used to help determine which of the templates 290 correspond to the log entry. The time stamp organizer 270 determines elapsed time between adjacent log entries and reduces the size of the later log entry by replacing a time stamp with an elapsed time.

Data, metadata, documents, instructions, or any suitable combination thereof may be stored and accessed by the storage module 280. For example, local storage of the application server 130A, such as a hard drive, may be used. As another example, network storage may be accessed by the storage module 280 via the network 190.

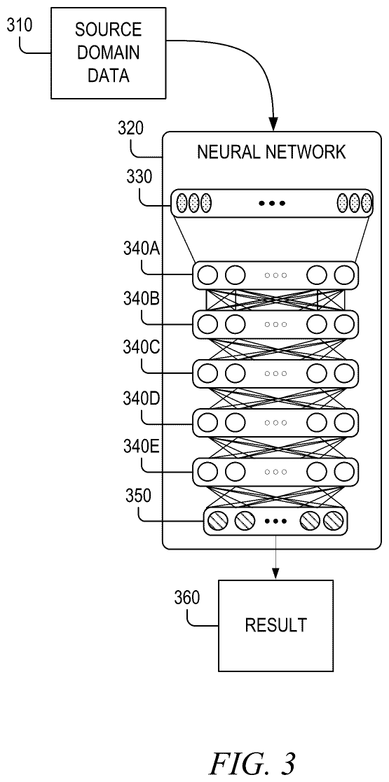

FIG. 3 is a block diagram of a neural network 320, suitable for determining log templates, embedding vectors, or any suitable combination thereof. The neural network 320 takes source domain data 310 as input, processes the source domain data 310 using the input layer 330; the intermediate, hidden layers 340A, 340B, 340C, 340D, and 340E; and the output layer 350 to generate a result 360.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output, and are completely internal to the neural network 320. Though five hidden layers are shown in FIG. 3, more or fewer hidden layers may be used.

A model may be run against a training dataset for several epochs (e.g., iterations), in which the training dataset is repeatedly fed into the model to refine its results. For example, in a supervised learning phase, a model is developed to predict the output for a given set of inputs, and is evaluated over several epochs to more reliably provide the output that is specified as corresponding to the given input for the greatest number of inputs for the training dataset. In another example, for an unsupervised learning phase, a model is developed to cluster the dataset into n groups, and is evaluated over several epochs as to how consistently it places a given input into a given group and how reliably it produces the n desired clusters across each epoch.

Once an epoch is run, the model is evaluated and the values of its variables are adjusted to attempt to better refine the model in an iterative fashion. In various aspects, the evaluations are biased against false negatives, biased against false positives, or evenly biased with respect to the overall accuracy of the model. The values may be adjusted in several ways depending on the machine learning technique used. For example, in a genetic or evolutionary algorithm, the values for the models that are most successful in predicting the desired outputs are used to develop values for models to use during the subsequent epoch, which may include random variation/mutation to provide additional data points. One of ordinary skill in the art will be familiar with several other machine learning algorithms that may be applied with the present disclosure, including linear regression, random forests, decision tree learning, neural networks, deep neural networks, etc.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network, a recurrent neural network, or another type of neural network. A neuron is an architectural element used in data processing and artificial intelligence, particularly machine learning which includes memory that may determine when to “remember” and when to “forget” values held in that memory based on the weights of inputs provided to the given neuron. An example type of neuron in the neural network 320 is a Long Short Term Memory (LSTM) node. Each of the neurons used herein are configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance are related to one another.

For example, an LSTM serving as a neuron includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learnt the object and name, may use the analytic results to identify the object in untagged images. A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of nonlinear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as a stochastic gradient descent (SGD) method.

Use of backpropagation can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

The transformer architecture processes an entire input at once rather than sequentially. For example, a RNN processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating AI, and the like) being provided as an input for determining the next result.

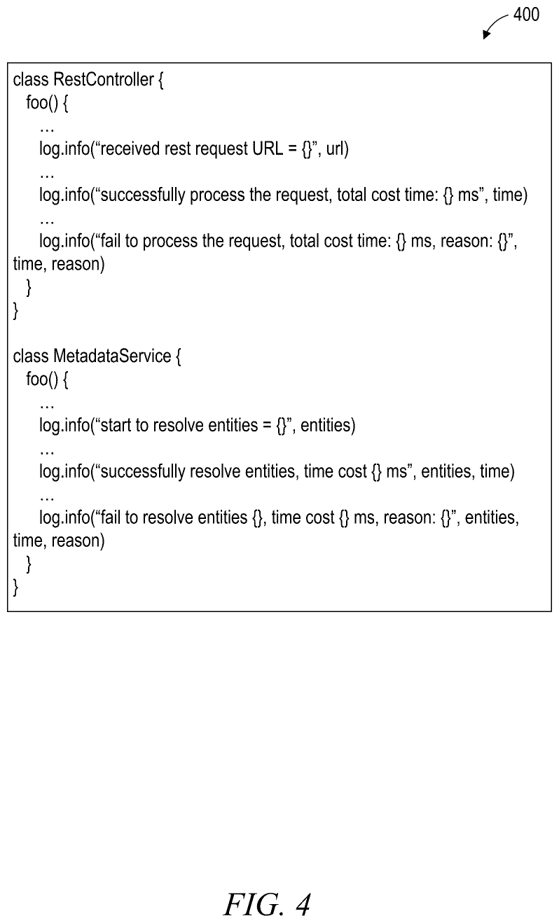

FIG. 4 shows an example of source code 400 for a computer program that generates log entries. The source code 400 defines two classes, RestController and MetadataService. Each of the two classes implements a method, foo( ). The functional portions of the methods have been replaced with ellipses, leaving only the method calls that generate log entries. The source code 400 may be provided as part of a prompt to an LLM. The LLM is instructed to determine log entry templates from the source code 400.

The method call that generates the log entries may include additional information not explicitly specified as parameters. In various example embodiments, the additional information includes a timestamp, a trace identifier, a tenant identifier, a user identifier, a source file name, or any suitable combination thereof. For example, log entries may be formatted as shown below, where a variable name in curly braces is replaced by the value of the variable:
[{timestamp}][{traceId}][{tenant Id}][{user Id}][{sourceFi leName}] {log content}

Thus, an example log entry created by the RestController being run by userA of tenantA is:
[2024-01-09T10:34:45.123][43555122112][tenantA][userA]
[RestController] received rest request URL=/rest/v1/Prod

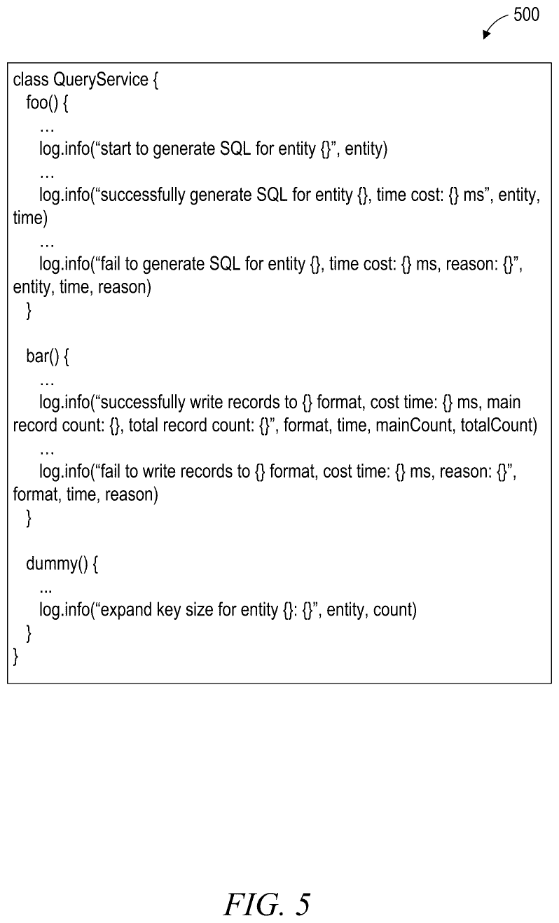

FIG. 5 shows an example of source code 500 for a computer program that generates log entries. The source code 500 defines one class, QueryService. The QueryService class implements three methods, foo( ), bar( ), and dummy( ). As in FIG. 4, the functional portions of the methods have been replaced with ellipses, leaving only the method calls that generate log entries. The source code 500 may also be provided as part of a prompt to an LLM. The LLM is instructed to determine log entry templates from the source code 500.

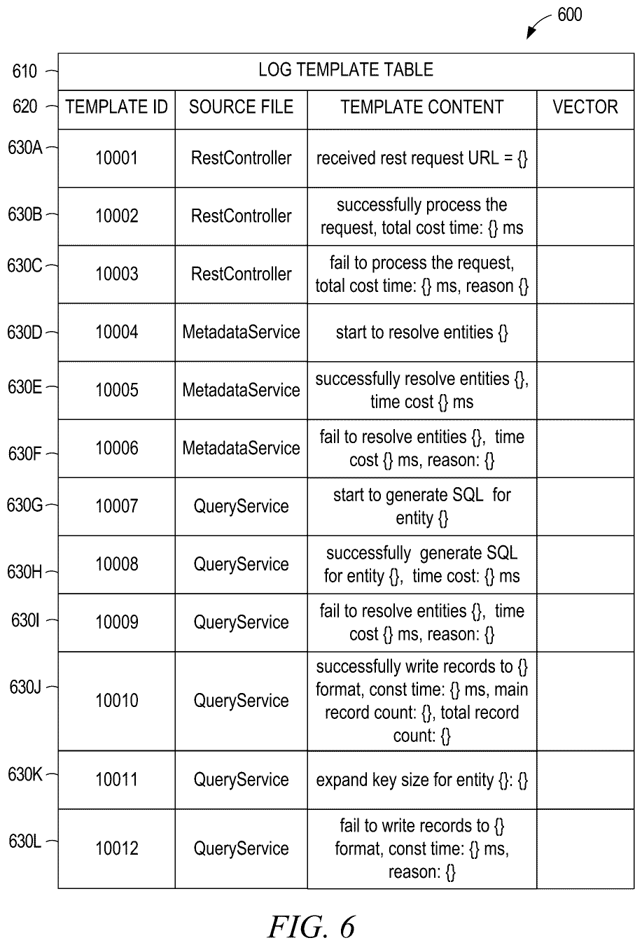

FIG. 6 shows an example database schema 600 for storing log templates. The database schema 600 includes a log template table 610. The log template table 610 includes rows 630A, 630B, 630C, 630D, 630E, 630F, 630G, 630H, 630I, 630J, 630K, and 630L of a format 620. Data in the rows 630A-630L may be generated by an LLM in response to one or more prompts that collectively include the source code 400 and 500 of FIGS. 4-5.

Each of the rows 630A-630L includes a template identifier, a source file identifier or name, template content, and an embedding vector. The template identifier is a unique identifier assigned to the log template. The source file identifier or name identifies the source code file in which the log template was detected. The template content is a portion of the source code file that is used by the source code to generate log entries. The embedding vector is a high-dimensional vector (e.g., a 1536-dimensional vector) representation of the semantic meaning of the template content. An example N-dimension embedding vector is as follows.

v=[0.0001, 0.0015, −0.0030, . . . , 0.0002] (N elements in the vector)

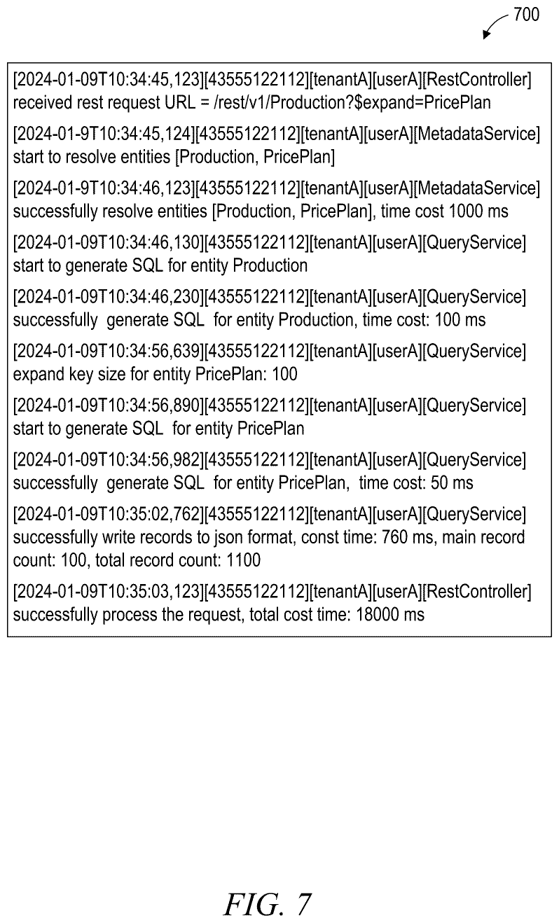

FIG. 7 shows an example log file 700. Each log entry in the log file 700 was created by one of the log.info( ) calls shown in FIGS. 4 and 5. The log entries use the example format discussed above with respect to FIG. 4, including a timestamp, a traceId, a tenantId, a userId, a sourceFileName, and log content. In the example of FIG. 7, all of the log entries are for the same trace, tenant, and user.

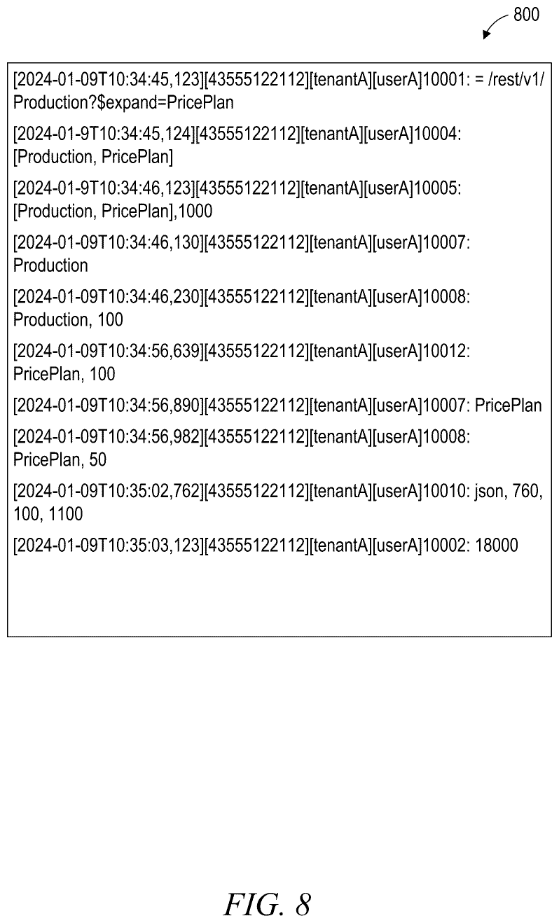

FIG. 8 shows a compressed log file 800, which is the example log file 700 of FIG. 7, reduced in size by the use of reference to log templates. The compressed log file 800 includes the timestamp, traceId, tenantId, and userId information of the log file 700. However, the sourceFileName and a portion of the log content have been replaced by a template identifier.

For example, the first log entry has replaced
[RestController] received rest request URL=/rest/v1/Production? $expand=PricePlan
with
10001: =/rest/v1/Production? $expand=PricePlan

Row 630A of the log template table 610 of FIG. 6 shows that template identifier 10001 is from source file RestController and that the template content is “received rest request URL={ }.” Thus, by accessing the log template data using the template identifier in the log entry, the sourceFileName and removed portion of the log content can be retrieved. As can be seen by comparison of FIGS. 7 and 8, the size of the log file 700 has been reduced. Since each log template is stored only once in the log template table 610 regardless of the number of log entries that are stored using the template, the total storage used for the log data is also reduced.

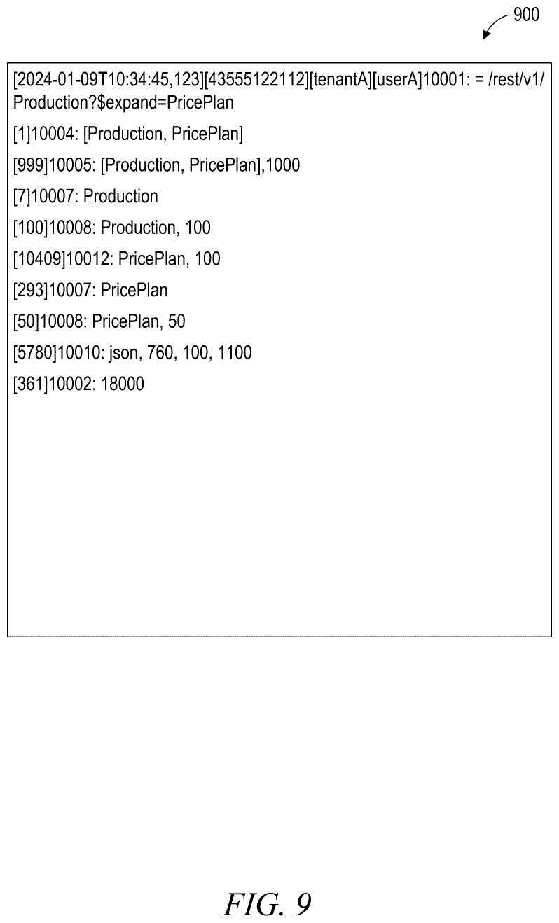

FIG. 9 shows a compressed log file 900, which is the compressed log file of FIG. 8, further reduced in size by the use of relative timestamps. The first log entry in the compressed log file 900 is identical to the first log entry in the compressed log file 800. For each subsequent log entry, if the log entry has the same traceId, tenantId, and userId as the previous log entry, those three fields are removed from the log entry. When reading the log data, if those values are missing, they are simply treated as being the same as in the previous entry.

Additionally, the first log entry has a full timestamp. The subsequent entries include an amount of elapsed time since the previous log entry. During creation of the compressed log file 900, the amount of elapsed time is determined by subtracting the timestamp of the previous log entry from the timestamp of the current log entry. During reading of the compressed log file 900, the timestamp for a log entry is determined by adding the elapsed time to the timestamp of the previous log entry. Thus, all of the information in the compressed log file 800 may be determined from the compressed log file 900, but as can be seen by comparison of FIGS. 8 and 9, the compressed log file 900 is substantially smaller than the compressed log file 800.

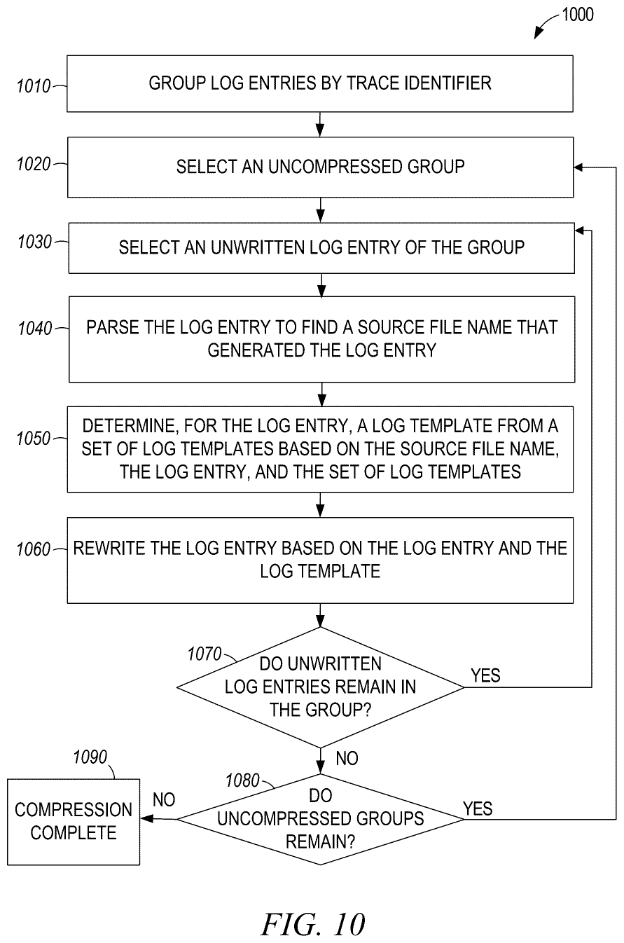

FIG. 10 shows an example flowchart of a method 1000 for efficiently storing log data. The method 1000 includes operations 1010, 1020, 1030, 1040, 1050, 1060, 1070, 1080, and 1090. By way of example and not limitation, the method 1000 is described as being performed by the application server 130A of FIG. 1, using the modules of FIG. 2, the machine learning model of FIG. 3, the source code of FIGS. 4-5, the database schema of FIG. 6, and the log file 700 of FIG. 7.

In operation 1010, the log grouper 250 accesses the log file 700 and groups log entries stored therein by trace identifier. For example, the log file 700 may include log entries generated by multiple users, multiple sessions for a single user, or any suitable combination thereof. In some example embodiments, each session for each user is assigned a unique trace identifier. The log entries may be in chronological order, thus interleaving log entries for different trace identifiers. In operation 1010, the log entries are grouped by trace identifier, allowing for the remainder of the method 1000 to proceed on each group independently. For example, a first chronological log entry with a trace identifier may be identified as a first log entry of a group and each subsequent log entry with the same trace identifier added to the group.

The log module 240, in operation 1020, selects an uncompressed group of the log entries. In various example embodiments, the group having the first uncompressed log entry is selected, the group having the lowest valued trace identifier is selected, the largest group is selected, or any suitable combination of these criteria are used to select the group.

In operation 1030, the log module 240 selects an unwritten log entry of the group. Initially, all log entries are unwritten. The unwritten log entry may be selected from among the log entries of the group in chronological order. For illustration purposes, the first log entry of the log file 700 may be selected:
[2024-01-09T10:34:45, 123][43555122112][tenantA][userA][RestController] received rest request URL=/rest/v1/Production? $expand=PricePlan

The parser 260, in operation 1040, parses the log entry to find a source file name that generated the log entry. For example, the format of the log entries may be predefined and consistent, allowing for programmatic extraction of the source file name. As another example, the format of the log entries may be less consistent and an LLM may have more success is determining the source file name. A separate prompt may be provided to the LLM to find the source file name from the log entry. Continuing with this example, the source file name is RestController.

In operation 1050, the LLM module 230 causes an LLM to determine, for the log entry, a log template from a set of log templates based on the source file name, the log entry, and the set of log templates. In this example, the set of log templates are stored in the log template table 610 of FIG. 6. Each of the log templates includes a template identifier and a source file name. Since the source file name is RestController, the log templates of the rows 630A-630C are available options. The LLM may determine a vector representation for the log entry. A cosine correlation coefficient for the vector representation for the log entry and each of the vector representations stored in the log template table 610 may be determined. The log entry having the largest cosine correlation coefficient value among the log templates of the rows 630A-630C may be the determined log template. In this example, the determined log template is the one with template identifier 10001 of the row 630A.

The cosine correlation coefficient between two vectors vₗ and vₜ may be calculated using the formula below. The vector vₗ is the embedding vector for a log entry. The vector vₜ is the embedding vector for a log template. N is the dimension of the embedding vector, v_{l,n} is the nth element of vₗ and vd is the nth element of vₜ.

$${c}_{l , t} = \frac{{\sum }_{n = 1}^{N} ( {v}_{l , n} \cdot {v}_{t , n} )}{\sqrt{{\sum }_{n = 1}^{N} {( {v}_{l , n} )}^{2} \cdot \sqrt{{\sum }_{n = 1}^{N} {( {v}_{t , n} )}^{2}}}}$$

The log module 240 rewrites the log entry based on the log entry and the log template (operation 1060). The rewriting of the log entry may include removing one or more portions of the log entry and replacing the removed portions with an identifier of the log template. The removed portions may be the portions that are stored in the log template. In this example, the log template stores the file name and the text “received rest request URL=.” Accordingly, the first log entry of the log file 700 may be rewritten as the first log entry of the compressed log file 800, as shown below:
[2024-01-09T10:34:45, 123][43555122112][tenantA][userA] 10001: =/rest/v1/Production? $expand=PricePlan

As can be seen in the example above, the rewritten log entry includes the log template identifier and the parameters provided to the log method call. Operations 1040-1060 serve to compress a single log entry. In operation 1070, the log module 240 determines if unwritten log entries remain in the group. If so, the method 1000 returns to operation 1030 to select an unwritten log entry of the group. Operations 1040-1060 are repeated to compress the next log entry. In this way, all log entries of the group are compressed.

Once no unwritten log entries remain in the group (operation 1070), the method 1000 proceed with operation 1080. In operation 1080, the log module 240 determines if any uncompressed groups remain. If there is at least one remaining uncompressed group, the method 1000 returns to operation 1020 to select the next uncompressed group. Log entries of the uncompressed group are compressed by operations 1030-1070. Thus, all log entries of all groups are compressed. Once no uncompressed groups remain (operation 1080), compression is complete (operation 1090).

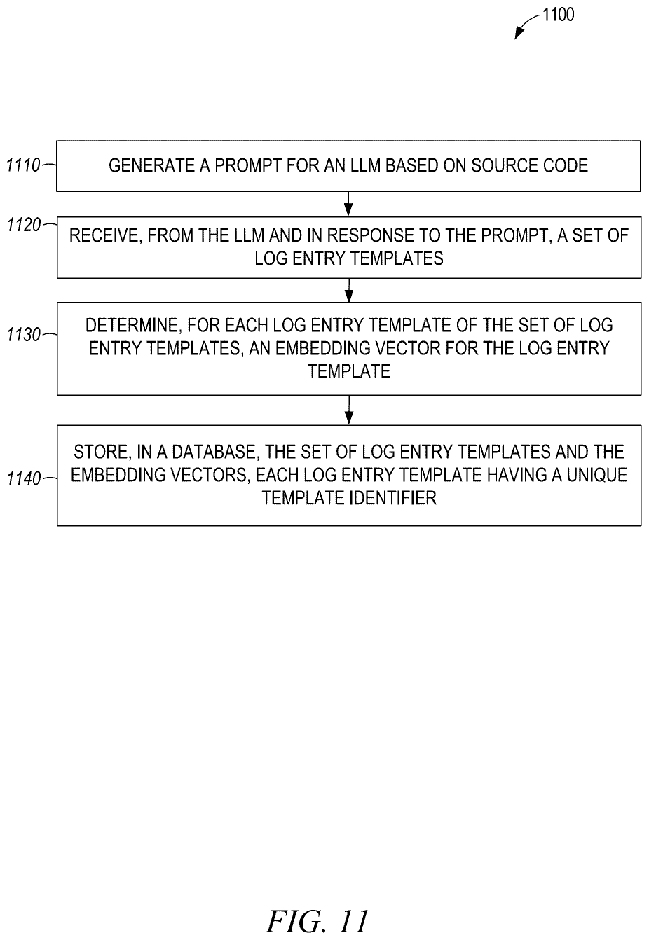

FIG. 11 shows an example flowchart of a method 1100 for efficiently storing log data. The method 1100 includes operations 1110, 1120, 1130, and 1140. By way of example and not limitation, the method 1100 is described as being performed by the application server 130A of FIG. 1, using the modules of FIG. 2, the machine learning model of FIG. 3, the source code of FIGS. 4-5, the database schema of FIG. 6, and the log file 700 of FIG. 7.

In operation 1110, the LLM module 230 generates a prompt for an LLM based on source code. The prompt may include a first potion that provides instructions and a second portion that includes the source code. An example first portion is:

You will be provided with source code that includes method calls that generate log entries. Your task is to generate a set of log entry templates, one log entry template for each different log entry format that is used by the method calls that generate log entries.

Each log entry template should be on a different line of your response. Your response should not include anything other than the log entry templates.

An example second portion is taken from the source code 400 of FIG. 4:

```
class RestController {
  foo( ) {
    ...
    log.info(“received rest request URL = { }”, url)
    ...
    log.info(“successfully process the request, total
cost time: { } ms”, time)
    ...
    log.info(“fail to process the request, total cost
time: { } ms, reason: { }”, time, reason)
  }
}
```

In some example embodiments, the second portion includes source code from multiple source code files. For example, the LLM may be provided links to the source code files of FIGS. 4 and 5.

The LLM module 230, in operation 1120, receives from the LLM and in response to the prompt, a set of log entry templates. For example, the output to the prompt above may be:
received rest request URL={ }
successfully process the request, total cost time: { } ms fail to process the request, total cost time: { } ms, reason: { }

In the above example, the prompt to the LLM includes source code for a single file or class. The output log entry templates are those generated by the file or class. In other example embodiments, the prompt to the LLM includes source code for multiple files or classes, and the output from the LLM indicates, for each log entry template, which file or class uses the log entry template.

In operation 1130, the LLM determines, for each log entry template of the set of log entry templates, an embedding vector for the log entry template. The determining of the embedding vectors may be performed in response to a single prompt for the set of log entry templates, or a separate prompt for each log entry template. An example prompt to determine an embedding vector for the first log entry template is:
Provide a 1536-dimensional vector that represents the semantic meaning of “received rest request URL={ }”

The log module 240, in operation 1140 stores, in a database, the set of log entry templates and the embedding vectors, each log entry template having a unique template identifier. A template identifier may be assigned sequentially to each log entry template. The stored data may include a file name or a class name that uses the log entry template. Thus, the log template table 610 of FIG. 6 may be populated in operation 1140. After operation 1110-1140 are complete, the method 1000 may be used to compress log entries by referencing the stored log entry templates.

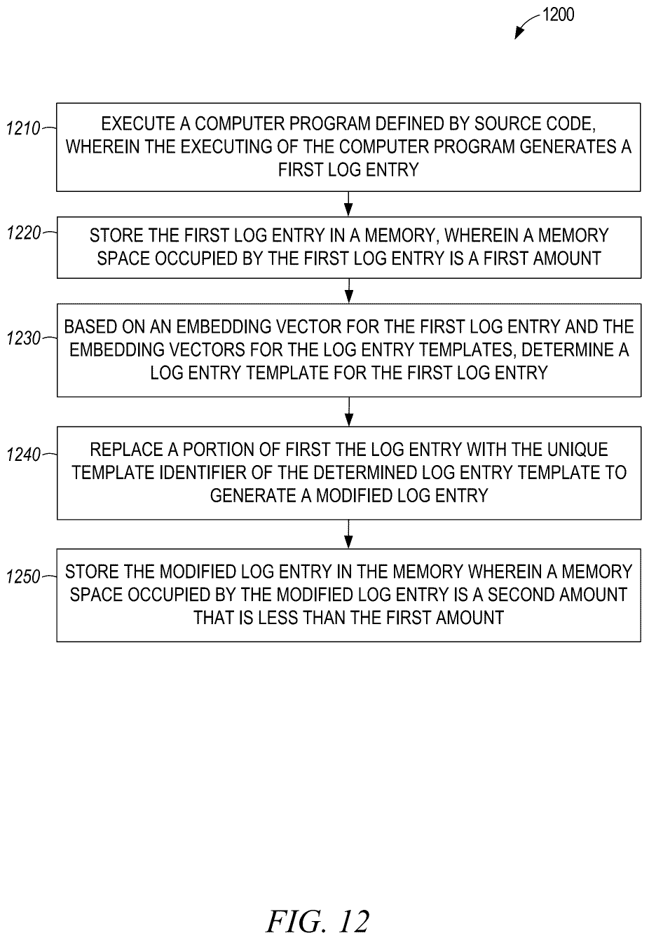

FIG. 12 shows an example flowchart of a method 1200 for efficiently storing log data. The method 1200 includes operations 1210, 1220, 1230, 1240, and 1250. By way of example and not limitation, the method 1200 is described as being performed by the application server 130A of FIG. 1, using the modules of FIG. 2, the machine learning model of FIG. 3, the source code of FIGS. 4-5, the database schema of FIG. 6, and the log file 700 of FIG. 7. The method 1200 may be performed after the method 1100.

In operation 1210, the application server 130A executes a computer program defined by source code, wherein the executing of the computer program generates a first log entry. For example, the source code of FIGS. 4-5 may be compiled into a computer program comprising instructions suitable for execution by one or more hardware processors. When the instructions corresponding to the log generating commands shown in FIGS. 4-5 are executed, log entries are generated. Here, “first log entry” just refers to a particular log entry, not necessarily the first log entry generated by the executing of the computer program.

The application server 130A, in operation 1220, stores the first log entry in a memory, wherein a memory space occupied by the first log entry is a first amount. As an example, the first log entry in the example log file 700 is:
[2024-01-09T10:34:45, 123][43555122112][tenantA][userA][RestContro ller] received rest request URL=/rest/v1/Production?$expand=PricePlan

The log entry occupies an amount of memory space that depends on the size of the log entry. For example, a fixed amount of memory space may be used for the existence of the log entry, plus one or two bytes for each character in the log entry. Accordingly, shorter log entries occupy smaller amounts of memory space.

In operation 1230, based on an embedding vector for the first log entry and the embedding vectors for the log entry templates, the log module 240 determines a log entry template for the first log entry. The embedding vector for the log entry may be determined by an LLM (e.g., in response to a prompt from the LLM module 230) or by a smaller machine-learning model or algorithm that is dedicated to the task of generating embedding vectors. The determining of the log entry template for the log entry may include determining a value for each of the log entry templates (or a subset thereof). The value for a log entry template may be the cosine correlation coefficient between the embedding vector for the log entry and the embedding vector for the log entry template.

If, in operation 1230, no log entry template for the first log entry is found, the method 1200 may terminate without modifying the first log entry. As a result, the first amount of memory space occupied by the first log entry remains unchanged.

The log module 240, in operation 1240, replaces a portion of the first log entry with the unique template identifier of the determined log entry template to generate a modified log entry. For example, the portion “[RestController] received rest request URL=” of the first log entry of FIG. 7 may be replaced by the unique template identifier “10001” of the log entry template of the row 630A of FIG. 6.

In operation 1250, the log module 240 stores the modified log entry in the memory, wherein a memory space occupied by the modified log entry is a second amount that is less than the first amount. In this example, the modified log entry contains 38 fewer characters than the first log entry, and thus occupies a smaller amount of memory space. After operation 1250 is performed, the first log entry may be deleted. The method 1200 may be repeated for each log entry generated by the computer program.

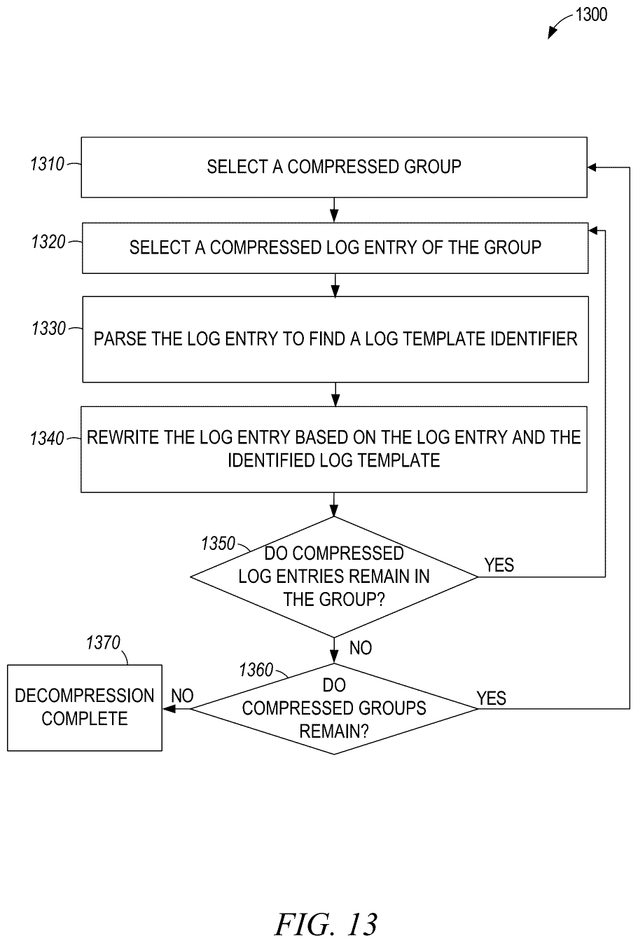

FIG. 13 shows an example flowchart of a method 1000 for decompressing compressed log data. The method 1300 includes operations 1310, 1320, 1330, 1340, 1350, 1360, and 1370. By way of example and not limitation, the method 1300 is described as being performed by the application server 130A of FIG. 1, using the modules of FIG. 2, the machine learning model of FIG. 3, the source code of FIGS. 4-5, the database schema of FIG. 6, and the log file 700 of FIG. 7.

The log module 240, in operation 1310, selects a compressed group of log entries. For example, with reference to FIG. 9, the first entry of a compressed group of log entries may be recognized because it contains a full timestamp, such as “2024-01-09T10:34:45,123,” rather than an elapsed time since a previous timestamp, such as “1” or “999.”

In operation 1320, the log module 240 selects a compressed log entry of the group. Initially, all log entries are compressed. The compressed log entry may be selected from among the log entries of the group in chronological order. For illustration purposes, the first log entry of the log file 900 may be selected:
[2024-01-09T10:34:45, 123][43555122112][tenantA][userA] 10001: =/rest/v1/Production? $expand=PricePlan

The parser 260, in operation 1330, parses the log entry to find a log template identifier. For example, the format of the log entries may be predefined and consistent, allowing for programmatic extraction of the log template identifier. As another example, the format of the log entries may be less consistent and an LLM may have more success is determining the log template identifier. A separate prompt may be provided to the LLM to find the log template identifier from the log entry. Continuing with this example, the log template identifier is 10001.

The log module 240 rewrites the log entry based on the log entry and the identified log template (operation 1340). The rewriting of the log entry may include removing the identifier of the log template and restoring portions of the log entry that were removed during compression. The row 630A of the log template table 610 of FIG. 6 shows that the template content includes the text “received rest request URL=,” and originates from the source file “RestController.” Accordingly, the first log entry of the log file 900 may be rewritten as shown below:
[2024-01-09T10:34:45, 123][43555122112][tenantA][userA][RestContro ller] received rest request URL=/rest/v1/Production? $expand=PricePlan

As can be seen in the example above, the rewritten log entry includes all of the information that was present in the first log entry of the log file 700 of FIG. 7. Operations 1320-1340 serve to decompress a single log entry. In operation 1350, the log module 240 determines if compressed log entries remain in the group. If so, the method 1300 returns to operation 1320 to select an unwritten log entry of the group. For example, the next compressed log entry of the log file 900, shown below, may be selected.
[1] 10004: [Production, PricePlan]

This log entry shows that the elapsed time from the previous log entry is one millisecond. Accordingly, the timestamp for this log entry is determined by adding one millisecond to the timestamp for the previous log entry, resulting in “2024-01-09T10:34:45,124.” The identifier of the log template in this log entry is 10004. Repeating operations 1330 and 1340 for this log entry results in the uncompressed log entry shown below.
[2024-01-9T10:34:45, 124][43555122112][tenantA][userA][MetadataSer vice] start to resolve entities [Production, PricePlan]

Operations 1320-1340 are repeated until all log entries of the group are compressed. Once no unwritten log entries remain in the group (operation 1350), the method 1300 proceeds with operation 1360. In operation 1360, the log module 240 determines if any compressed groups remain. If there is at least one remaining compressed group, the method 1300 returns to operation 1310 to select the next compressed group. Log entries of the compressed group are decompressed by operations 1320-1350. Thus, all log entries of all groups are decompressed. Once no compressed groups remain (operation 1360), decompression is complete (operation 1370).

In view of the above-described implementations of subject matter this application discloses the following list of examples. One feature of an example in isolation or more than one feature of an example, taken in combination and, optionally, in combination with one or more features of one or more further examples are further examples also falling within the disclosure of this application.

Example 1 is a system comprising: one or more hardware processors; and a memory that stores instructions that, when executed by the one or more hardware processors, cause the one or more hardware processors to perform operations comprising: executing a computer program defined by source code, wherein the executing of the computer program generates a first log entry; storing the first log entry in the memory, wherein a memory space occupied by the first log entry is a first amount; generating a prompt for a large language model (LLM) based on the source code; receiving, from the LLM and in response to the prompt, a set of log entry templates; determining, for each log entry template of the set of log entry templates, an embedding vector for the log entry template; storing, in a database, the set of log entry templates and the embedding vectors, each log entry template having a unique template identifier; based on an embedding vector for the first log entry and the embedding vectors for the log entry templates, determining a log entry template for the first log entry; replacing a portion of the first log entry with the unique template identifier of the determined log entry template to generate a modified log entry; and storing the modified log entry in the memory wherein a memory space occupied by the modified log entry is a second amount that is less than the first amount.

In Example 2, the subject matter of Example 1, wherein the determining of the log entry template for the first log entry comprises: determining a source code file for the first log entry; and determining a cosine correlation coefficient between the embedding vector for the first log entry and each log entry template for the source code file; wherein the database stores log entry templates for a plurality of source code files.

In Example 3, the subject matter of Examples 1-2, wherein the operations further comprise: determining that a series of log entries in a log file all have a same trace identifier; and removing the trace identifier from all but one log entry in the series.

In Example 4, the subject matter of Example 3, wherein the operations further comprise: determining an elapsed time between a second log entry in the series and an earliest log entry in the series; and reducing a size of the second log entry by replacing a timestamp in the second log entry with the elapsed time.

In Example 5, the subject matter of Examples 1-4, wherein the first log entry comprises a timestamp, a trace identifier, a user identifier, a source file name, and log content.

In Example 6, the subject matter of Examples 1-5, wherein the operations further comprise determining the embedding vector for the first log entry by the LLM.

In Example 7, the subject matter of Examples 1-6, wherein the operations further comprise: storing a second log entry generated by the computer program in the memory, wherein a second memory space occupied by the second log entry is a third amount; based on an embedding vector for the second log entry and the embedding vectors for the log entry templates, determining that no log entry template matches the second log entry; and maintaining storage of the second log entry that occupies the third amount of memory space.

In Example 8, the subject matter of Examples 1-7, wherein the operations further comprise: accessing, based on the unique template identifier in the stored modified log entry, the log entry template; and restoring the replaced portion of the first log entry by replacing the unique template identifier with text from the log entry template.

Example 9 is a non-transitory computer-readable medium that stores instructions that, when executed by one or more processors, cause the one or more processors to perform operations comprising: executing a computer program defined by source code, wherein the executing of the computer program generates a first log entry; storing the first log entry in a memory, wherein a memory space occupied by the first log entry is a first amount; generating a prompt for a large language model (LLM) based on the source code; receiving, from the LLM and in response to the prompt, a set of log entry templates; determining, for each log entry template of the set of log entry templates, an embedding vector for the log entry template; storing, in a database, the set of log entry templates and the embedding vectors, each log entry template having a unique template identifier; based on an embedding vector for the first log entry and the embedding vectors for the log entry templates, determining a log entry template for the first log entry; replacing a portion of the first log entry with the unique template identifier of the determined log entry template to generate a modified log entry; and storing the modified log entry in the memory wherein a memory space occupied by the modified log entry is a second amount that is less than the first amount.

In Example 10, the subject matter of Example 9, wherein the determining of the log entry template for the first log entry comprises: determining a source code file for the first log entry; and determining a cosine correlation coefficient between the embedding vector for the first log entry and each log entry template for the source code file; wherein the database stores log entry templates for a plurality of source code files.

In Example 11, the subject matter of Examples 9-10, wherein the operations further comprise: determining that a series of log entries in a log file all have a same trace identifier; and removing the trace identifier from all but one log entry in the series.

In Example 12, the subject matter of Example 11, wherein the operations further comprise: determining an elapsed time between a second log entry in the series and an earliest log entry in the series; and reducing a size of the second log entry by replacing a timestamp in the second log entry with the elapsed time.

In Example 13, the subject matter of Examples 9-12, wherein the first log entry comprises a timestamp, a trace identifier, a user identifier, a source file name, and log content.

In Example 14, the subject matter of Examples 9-13, wherein the operations further comprise determining the embedding vector for the first log entry by the LLM.

In Example 15, the subject matter of Examples 9-14, wherein the operations further comprise: storing a second log entry generated by the computer program in the memory, wherein a second memory space occupied by the second log entry is a third amount; based on an embedding vector for the second log entry and the embedding vectors for the log entry templates, determining that no log entry template matches the second log entry; and maintaining storage of the second log entry that occupies the third amount of memory space.

Example 16 is a method comprising: executing, by one or more hardware processors, a computer program defined by source code, wherein the executing of the computer program generates a first log entry; storing the first log entry in a memory, wherein a memory space occupied by the first log entry is a first amount; generating a prompt for a large language model (LLM) based on the source code; receiving, from the LLM and in response to the prompt, a set of log entry templates; determining, for each log entry template of the set of log entry templates, an embedding vector for the log entry template; storing, in a database, the set of log entry templates and the embedding vectors, each log entry template having a unique template identifier; based on an embedding vector for the first log entry and the embedding vectors for the log entry templates, determining a log entry template for the first log entry; replacing a portion of the first log entry with the unique template identifier of the determined log entry template to generate a modified log entry; and storing the modified log entry in the memory wherein a memory space occupied by the modified log entry is a second amount that is less than the first amount.

In Example 17, the subject matter of Example 16, wherein the determining of the log entry template for the first log entry comprises: determining a source code file for the first log entry; and determining a cosine correlation coefficient between the embedding vector for the first log entry and each log entry template for the source code file; wherein the database stores log entry templates for a plurality of source code files.

In Example 18, the subject matter of Examples 16-17 includes determining that a series of log entries in a log file all have a same trace identifier; and removing the trace identifier from all but one log entry in the series.

In Example 19, the subject matter of Examples 16-18 includes determining an elapsed time between a second log entry in the series and an earliest log entry in the series; and reducing a size of the second log entry by replacing a timestamp in the second log entry with the elapsed time.

In Example 20, the subject matter of Examples 16-19, wherein the first log entry comprises a timestamp, a trace identifier, a user identifier, a source file name, and log content.

Example 21 is an apparatus comprising means to implement any of Examples 1-20.

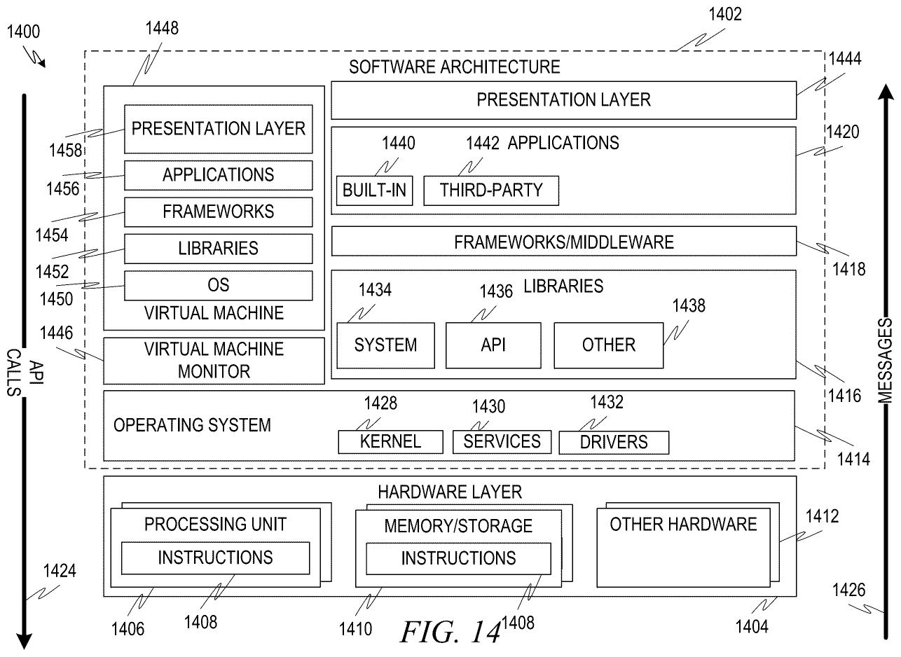

FIG. 14 shows a block diagram 1400 showing one example of a software architecture 1402 for a computing device. The software architecture 1402 may be used in conjunction with various hardware architectures, for example, as described herein. FIG. 14 is merely a non-limiting example of a software architecture, and many other architectures may be implemented to facilitate the functionality described herein. A representative hardware layer 1404 is illustrated and can represent, for example, any of the above referenced computing devices. In some examples, the hardware layer 1404 may be implemented according to the architecture of the computer system of FIG. 15.

The representative hardware layer 1404 comprises one or more processing units 1406 having associated executable instructions 1408. Executable instructions 1408 represent the executable instructions of the software architecture 1402, including implementation of the methods, modules, subsystems, and components, and so forth described herein and may also include memory and/or storage modules 1410, which also have executable instructions 1408. Hardware layer 1404 may also comprise other hardware as indicated by other hardware 1412 which represents any other hardware of the hardware layer 1404, such as the other hardware illustrated as part of the software architecture 1402.

In the example architecture of FIG. 14, the software architecture 1402 may be conceptualized as a stack of layers where each layer provides particular functionality. For example, the software architecture 1402 may include layers such as an operating system 1414, libraries 1416, frameworks/middleware 1418, applications 1420, and presentation layer 1444. Operationally, the applications 1420 and/or other components within the layers may invoke API calls 1424 through the software stack and access a response, returned values, and so forth illustrated as messages 1426 in response to the API calls 1424. The layers illustrated are representative in nature and not all software architectures have all layers. For example, some mobile or special purpose operating systems may not provide a frameworks/middleware 1418 layer, while others may provide such a layer. Other software architectures may include additional or different layers.

The operating system 1414 may manage hardware resources and provide common services. The operating system 1414 may include, for example, a kernel 1428, services 1430, and drivers 1432. The kernel 1428 may act as an abstraction layer between the hardware and the other software layers. For example, the kernel 1428 may be responsible for memory management, processor management (e.g., scheduling), component management, networking, security settings, and so on. The services 1430 may provide other common services for the other software layers. In some examples, the services 1430 include an interrupt service. The interrupt service may detect the receipt of an interrupt and, in response, cause the software architecture 1402 to pause its current processing and execute an interrupt service routine (ISR) when an interrupt is accessed.

The drivers 1432 may be responsible for controlling or interfacing with the underlying hardware. For instance, the drivers 1432 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1416 may provide a common infrastructure that may be utilized by the applications 1420 and/or other components and/or layers. The libraries 1416 typically provide functionality that allows other software modules to perform tasks in an easier fashion than to interface directly with the underlying operating system 1414 functionality (e.g., kernel 1428, services 1430 and/or drivers 1432). The libraries 1416 may include system libraries 1434 (e.g., C standard library) that may provide functions such as memory allocation functions, string manipulation functions, mathematic functions, and the like. In addition, the libraries 1416 may include API libraries 1436 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1416 may also include a wide variety of other libraries 1438 to provide many other APIs to the applications 1420 and other software components/modules.

The frameworks/middleware 1418 may provide a higher-level common infrastructure that may be utilized by the applications 1420 and/or other software components/modules. For example, the frameworks/middleware 1418 may provide various graphical user interface (GUI) functions, high-level resource management, high-level location services, and so forth. The frameworks/middleware 1418 may provide a broad spectrum of other APIs that may be utilized by the applications 1420 and/or other software components/modules, some of which may be specific to a particular operating system or platform.

The applications 1420 include built-in applications 1440 and/or third-party applications 1442. Examples of representative built-in applications 1440 may include, but are not limited to, a contacts application, a browser application, a book reader application, a location application, a media application, a messaging application, and/or a game application. Third-party applications 1442 may include any of the built-in applications 1440 as well as a broad assortment of other applications. In a specific example, the third-party application 1442 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1442 may invoke the API calls 1424 provided by the mobile operating system such as operating system 1414 to facilitate functionality described herein.

The applications 1420 may utilize built-in operating system functions (e.g., kernel 1428, services 1430 and/or drivers 1432), libraries (e.g., system libraries 1434, API libraries 1436, and other libraries 1438), and frameworks/middleware 1418 to create user interfaces to interact with users of the system. Alternatively, or additionally, in some systems, interactions with a user may occur through a presentation layer, such as presentation layer 1444. In these systems, the application/module “logic” can be separated from the aspects of the application/module that interact with a user.

Some software architectures utilize virtual machines. In the example of FIG. 14, this is illustrated by virtual machine 1448. A virtual machine creates a software environment where applications/modules can execute as if they were executing on a hardware computing device. A virtual machine is hosted by a host operating system (operating system 1414) and typically, although not always, has a virtual machine monitor 1446, which manages the operation of the virtual machine 1448 as well as the interface with the host operating system (i.e., operating system 1414). A software architecture executes within the virtual machine 1448 such as an operating system 1450, libraries 1452, frameworks/middleware 1454, applications 1456 and/or presentation layer 1458. These layers of software architecture executing within the virtual machine 1448 can be the same as corresponding layers previously described or may be different.

### MODULES, COMPONENTS AND LOGIC

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

### Example Machine Architecture and Machine-Readable Medium

FIG. 15 shows a block diagram of a machine in the example form of a computer system 1500 within which instructions 1524 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a CPU, a graphics processing unit (GPU), or both), a main memory 1504, and a static memory 1506, which communicate with each other via a bus 1508. The computer system 1500 may further include a video display unit 1510 (e.g., a liquid crystal display (LCD) or a cathode ray tube [CRT]). The computer system 1500 also includes an alphanumeric input device 1512 (e.g., a keyboard or a touch-sensitive display screen), a user interface navigation (or cursor control) device 1514 (e.g., a mouse), a storage unit 1516, a signal generation device 1518 (e.g., a speaker), and a network interface device 1520.

### Machine-Readable Medium

The storage unit 1516 includes a machine-readable medium 1522 on which is stored one or more sets of data structures and instructions 1524 (e.g., software) embodying or utilized by any one or more of the methodologies or functions described herein. The instructions 1524 may also reside, completely or at least partially, within the main memory 1504 and/or within the processor 1502 during execution thereof by the computer system 1500, with the main memory 1504 and the processor 1502 also constituting a machine-readable medium 1522.

While the machine-readable medium 1522 is shown in FIG. 15 to be a single medium, the term “machine-readable medium” may include a single medium or multiple media (e.g., a centralized or distributed database, and/or associated caches and servers) that store the one or more instructions 1524 or data structures. The term “machine-readable medium” shall also be taken to include any tangible medium that is capable of storing, encoding, or carrying instructions 1524 for execution by the machine and that cause the machine to perform any one or more of the methodologies of the present disclosure, or that is capable of storing, encoding, or carrying data structures utilized by or associated with the instructions 1524. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1524 may further be transmitted or received over a communications network 1526 using a transmission medium. The instructions 1524 may be transmitted using the network interface device 1520 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1524 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

1. A system comprising:
one or more hardware processors; and
a memory that stores instructions that, when executed by the one or more hardware processors, cause the one or more hardware processors to perform operations comprising:
executing a computer program defined by source code that comprises log-generating statements, wherein the executing of the computer program generates a first log entry;
storing the first log entry in the memory, wherein a memory space occupied by the first log entry is a first amount;
generating a prompt for a large language model (LLM) based on the source code;
receiving, from the LLM and in response to the prompt, a set of log entry templates generated from the log-generating statements;
determining, for each log entry template of the set of log entry templates, an embedding vector for the log entry template;
storing, in a database, the set of log entry templates and the embedding vectors, each log entry template having a unique template identifier;
based on an embedding vector for the first log entry and the embedding vectors for the log entry templates, determining a log entry template for the first log entry;
replacing a portion of the first log entry with the unique template identifier of the determined log entry template to generate a modified log entry; and
storing the modified log entry in the memory wherein a memory space occupied by the modified log entry is a second amount that is less than the first amount.

2. The system of claim 1, wherein the determining of the log entry template for the first log entry comprises:
determining a source code file for the first log entry; and
determining a cosine correlation coefficient between the embedding vector for the first log entry and each log entry template for the source code file;
wherein the database stores log entry templates for a plurality of source code files.

3. The system of claim 1, wherein the operations further comprise:
determining that a series of log entries in a log file all have a same trace identifier; and
removing the trace identifier from all but one log entry in the series.

4. The system of claim 3, wherein the operations further comprise:
determining an elapsed time between a second log entry in the series and an earliest log entry in the series; and
reducing a size of the second log entry by replacing a timestamp in the second log entry with the elapsed time.

5. The system of claim 1, wherein the first log entry comprises a timestamp, a trace identifier, a user identifier, a source file name, and log content.

6. The system of claim 1, wherein the operations further comprise determining the embedding vector for the first log entry by the LLM.

7. The system of claim 1, wherein the operations further comprise:
storing a second log entry generated by the computer program in the memory, wherein a second memory space occupied by the second log entry is a third amount;
based on an embedding vector for the second log entry and the embedding vectors for the log entry templates, determining that no log entry template matches the second log entry; and
maintaining storage of the second log entry that occupies the third amount of memory space.

8. The system of claim 1, wherein the operations further comprise:
accessing, based on the unique template identifier in the stored modified log entry, the log entry template; and
restoring the replaced portion of the first log entry by replacing the unique template identifier with text from the log entry template.

9. A non-transitory computer-readable medium that stores instructions that, when executed by one or more processors, cause the one or more processors to perform operations comprising:
executing a computer program defined by source code that comprises log-generating statements, wherein the executing of the computer program generates a first log entry;
storing the first log entry in a memory, wherein a memory space occupied by the first log entry is a first amount;
generating a prompt for a large language model (LLM) based on the source code;
receiving, from the LLM and in response to the prompt, a set of log entry templates generated from the log-generating statements;
determining, for each log entry template of the set of log entry templates, an embedding vector for the log entry template;
storing, in a database, the set of log entry templates and the embedding vectors, each log entry template having a unique template identifier;
based on an embedding vector for the first log entry and the embedding vectors for the log entry templates, determining a log entry template for the first log entry;
replacing a portion of the first log entry with the unique template identifier of the determined log entry template to generate a modified log entry; and
storing the modified log entry in the memory wherein a memory space occupied by the modified log entry is a second amount that is less than the first amount.

10. The non-transitory computer-readable medium of claim 9, wherein the determining of the log entry template for the first log entry comprises:
determining a source code file for the first log entry; and
determining a cosine correlation coefficient between the embedding vector for the first log entry and each log entry template for the source code file;
wherein the database stores log entry templates for a plurality of source code files.

11. The non-transitory computer-readable medium of claim 9, wherein the operations further comprise:
determining that a series of log entries in a log file all have a same trace identifier; and
removing the trace identifier from all but one log entry in the series.

12. The non-transitory computer-readable medium of claim 11, wherein the operations further comprise:
determining an elapsed time between a second log entry in the series and an earliest log entry in the series; and
reducing a size of the second log entry by replacing a timestamp in the second log entry with the elapsed time.

13. The non-transitory computer-readable medium of claim 9, wherein the first log entry comprises a timestamp, a trace identifier, a user identifier, a source file name, and log content.

14. The non-transitory computer-readable medium of claim 9, wherein the operations further comprise determining the embedding vector for the first log entry by the LLM.

15. The non-transitory computer-readable medium of claim 9, wherein the operations further comprise:
storing a second log entry generated by the computer program in the memory, wherein a second memory space occupied by the second log entry is a third amount;
based on an embedding vector for the second log entry and the embedding vectors for the log entry templates, determining that no log entry template matches the second log entry; and
maintaining storage of the second log entry that occupies the third amount of memory space.

16. A method comprising:
executing, by one or more hardware processors, a computer program defined by source code that comprises log-generating statements, wherein the executing of the computer program generates a first log entry;
storing the first log entry in a memory, wherein a memory space occupied by the first log entry is a first amount;
generating a prompt for a large language model (LLM) based on the source code;
receiving, from the LLM and in response to the prompt, a set of log entry templates generated from the log-generating statements;
determining, for each log entry template of the set of log entry templates, an embedding vector for the log entry template;
storing, in a database, the set of log entry templates and the embedding vectors, each log entry template having a unique template identifier;
based on an embedding vector for the first log entry and the embedding vectors for the log entry templates, determining a log entry template for the first log entry;
replacing a portion of the first log entry with the unique template identifier of the determined log entry template to generate a modified log entry; and
storing the modified log entry in the memory wherein a memory space occupied by the modified log entry is a second amount that is less than the first amount.

17. The method of claim 16, wherein the determining of the log entry template for the first log entry comprises:
determining a source code file for the first log entry; and
determining a cosine correlation coefficient between the embedding vector for the first log entry and each log entry template for the source code file;
wherein the database stores log entry templates for a plurality of source code files.

18. The method of claim 16, further comprising:
determining that a series of log entries in a log file all have a same trace identifier; and
removing the trace identifier from all but one log entry in the series.

19. The method of claim 16, further comprising:
determining an elapsed time between a second log entry in the series and an earliest log entry in the series; and
reducing a size of the second log entry by replacing a timestamp in the second log entry with the elapsed time.

20. The method of claim 16, wherein the first log entry comprises a timestamp, a trace identifier, a user identifier, a source file name, and log content.
